(19) United States
(12) Patent Application Publication
(10) Pub. No.: US 2013/0082942 A1
(43) Pub. Date: Apr. 4, 2013

(54) ELECTRONIC PAPER DISPLAY

(71) Applicant: Chin-Chi YU, HSINCHU (TW)

(72) Inventor: Chin-Chi YU, HSINCHU (TW)

(73) Assignee: E INK HOLDINGS INC., HSINCHU (TW)

(21) Appl. No.: 13/400,576

(22) Filed: Feb. 21, 2012

(30) Foreign Application Priority Data
Sep. 30, 2011 (TW) 100135546

(51) Int. Cl. G06F 3/041

(52) U.S. Cl. 345/173

(57) ABSTRACT

An electronic paper display is provided. The electronic paper display includes a first substrate including a thin film transistor layer, and a front panel laminate. The thin film transistor layer is located on a surface of the first substrate. The front panel laminate is located on the thin film transistor layer. The front panel laminate includes a second substrate, a common electrode layer, an electronic ink layer, and a touch sensing electrode layer. The second substrate includes a first surface facing the first substrate, and a second surface facing away from the first surface. The common electrode layer is located on the first surface of the second substrate. The electronic ink layer is located between the thin film transistor layer and the common electrode layer. The touch sensing electrode layer is directly formed on the second surface of the second substrate.

### RELATED APPLICATIONS

This application claims priority to Taiwan Application Serial Number 100135546, filed Sep. 30, 2011, which is herein incorporated by reference.

### BACKGROUND

1. Technical Field

The present disclosure relates to a display, more particularly to an electronic paper display.

2. Description of Related Art

A typical electronic paper display includes a front plane laminate (FPL) and a substrate having a thin film transistor layer. The front plane laminate includes an electronic ink layer and a common electrode layer. The electronic ink layer includes microcapsules, and each of the microcapsules has positive charges, negative charges, and a transparent fluid. The positive charges and the negative charges have different colors, such as black and white. When an electric field between a pixel electrode of the substrate having the thin film transistor layer and the common electrode layer is changed, the differently colored positive charges and negative charges move upward or downward in accordance with the directions of the electric field, such that the microcapsules display a black or white color. Therefore, users can see images displayed by the electronic paper display.

FIG. 1 is a sectional view of a conventional electronic paper display 100 having a touch function. Referring to FIG. 1, the electronic paper display 100 includes a substrate 110, a front plane laminate 120, and a touch panel 140. The substrate 110 includes a thin film transistor layer 112. The front plane laminate 120 includes an electronic ink layer 122, a common electrode layer 124, and a substrate 126. In addition, a protective sheet 130 may be mounted on the front plane laminate 120 to protect the front plane laminate 120. The touch panel 140 is adhered to the protective sheet 130.

However, with the conventional electronic paper display having a touch function described above, as a result of the configuration in which the touch panel is adhered to the protective sheet which, in turn, is disposed on the front plane laminate, the thickness and weight of the electronic paper display are increased. Moreover, since the manufacturing productivity associated with adhering the touch panel is not good, and the touch panel may cause a reduction in the optical properties and the reflective efficiency of the electronic paper display, the overall product quality competitiveness may degrade.

### SUMMARY

An aspect of the present invention is to provide an electronic paper display.

In an embodiment of the present invention, an electronic paper display includes a first substrate including a thin film transistor layer, and a front panel laminate. The thin film transistor layer is located on a surface of the first substrate. The front panel laminate is located on the thin film transistor layer. The front panel laminate includes a second substrate, a common electrode layer, an electronic ink layer, and a touch sensing electrode layer. The second substrate includes a first surface facing the first substrate, and a second surface facing away from the first surface. The common electrode layer is located on the first surface of the second substrate. The electronic ink layer is located between the thin film transistor layer and the common electrode layer. The touch sensing electrode layer is directly formed on the second surface of the second substrate.

In an embodiment of the present invention, the electronic paper display further includes a protective sheet located above the touch sensing electrode layer for protecting the front panel laminate.

In an embodiment of the present invention, the electronic paper display further includes a first contact hole and a first conductive adhesive. The first contact hole is located between the common electrode layer and the thin film transistor layer. The first conductive adhesive is located in the first contact hole for electrical connection to the common electrode layer and the thin film transistor layer.

In an embodiment of the present invention, the electronic paper display further includes a second contact hole and a second conductive adhesive. The second contact hole is located between the touch sensing electrode layer and the thin film transistor layer. The second conductive adhesive is located in the second contact hole for electrical connection to the touch sensing electrode layer and the thin film transistor layer.

In the aforementioned embodiment of the present invention, the front panel laminate includes the touch sensing electrode layer located on the second substrate, and the second conductive adhesive located in the second contact hole is electrically connected to the touch sensing electrode layer and the thin film transistor layer, such that the electronic paper display has a touch function. Compared with a conventional electronic paper display, because the electronic paper display does not include a touch panel which is adhered to the protective sheet as in the case of the conventional electronic paper display, the thickness and weight of the electronic paper display of the present invention may be reduced.

Furthermore, the touch sensing electrode layer may be formed on the second substrate by methods of slit coating, photolithography, or screen coating. Hence, the manufacturing productivity and overall quality of the electronic paper display produced by using the aforementioned methods are better than when adhering a touch panel to a protective sheet. As a result, the optical properties and reflective efficiency of the electronic paper display may be improved, such that the overall product quality and competitiveness may be enhanced.

### BRIEF DESCRIPTION OF THE DRAWINGS

FIG. 1 is a sectional view of a conventional electronic paper display having a touch function;

FIG. 2 is a sectional view of an electronic paper display of an embodiment of the present invention;

FIG. 3 is a partial enlarged view of the electronic paper display shown in FIG. 2;

FIG. 4 is a partial sectional view of an electronic paper display of an embodiment of the present invention;

FIG. 5 is a partial sectional view of an electronic paper display of an embodiment of the present invention;

FIG. 6 is a partial sectional view of an electronic paper display of an embodiment of the present invention;

FIG. 7 is a partial sectional view of an electronic paper display of an embodiment of the present invention;

FIG. 8 is a partial sectional view of an electronic paper display of an embodiment of the present invention;

FIG. 9 is a sectional view of an electronic paper display of an embodiment of the present invention;

FIG. 10 is a sectional view of an electronic paper display of an embodiment of the present invention;

FIG. 11 is a sectional view of an electronic paper display of an embodiment of the present invention;

FIG. 12 is a sectional view of an electronic paper display of an embodiment of the present invention; and

FIG. 13 is a sectional view of an electronic paper display of an embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

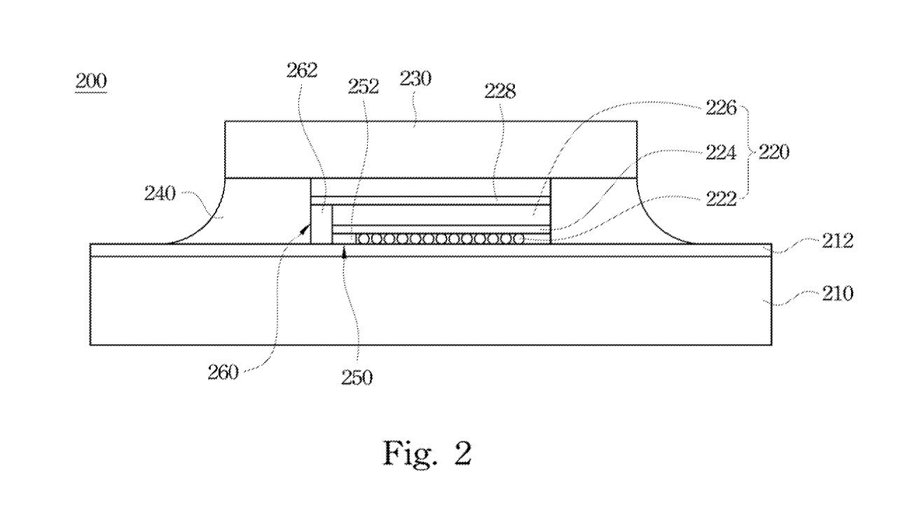

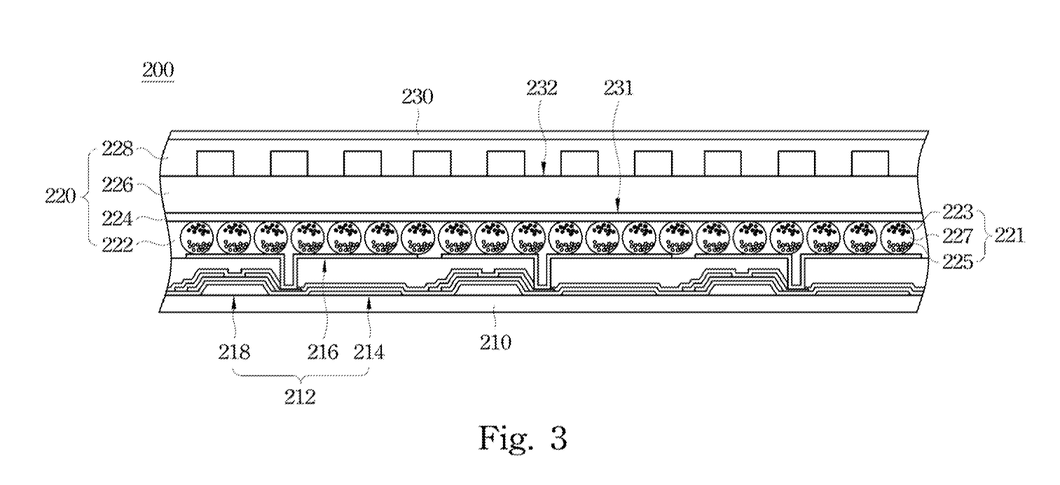

FIG. 2 is a sectional view of an electronic paper display 200 of an embodiment of the present invention. FIG. 3 is a partial enlarged view of the electronic paper display 200 shown in FIG. 2. As shown in FIG. 2 and FIG. 3, the electronic paper display 200 includes a first substrate 210 including a thin film transistor layer 212, and a front panel laminate 220. The thin film transistor layer 212 is located on a surface of the first substrate 210. The front panel laminate 220 is located on the thin film transistor layer 212. The front panel laminate 220 includes a second substrate 226, a common electrode layer 224, an electronic ink layer 222, and a touch sensing electrode layer 228. The second substrate 226 includes a first surface 231 facing the first substrate 210, and a second surface 232 facing away from the first surface 231. The common electrode layer 224 is located on the first surface 231 of the second substrate 226. The electronic ink layer 222 is located between the thin film transistor layer 212 and the common electrode layer 224. The touch sensing electrode layer 228 is directly formed on the second surface 232 of the second substrate 226. That is to say, in this embodiment, the touch sensing electrode layer 228 directly contacts to the second surface 232 of the second substrate 226.

The electronic ink layer 222 includes microcapsules 221, and each of the microcapsules 221 includes a transparent fluid 227, black charged particles 223, and white charged particles 225. The black charged particles 223 are located in the transparent fluid 227 and have negative charges. Moreover, the white charged particles 225 are also located in the transparent fluid 227 but have positive charges. The thin film transistor layer 212 includes a storage capacitor 214, a pixel electrode 216, and a thin film transistor 218.

In this embodiment, the electronic paper display 200 further includes a protective sheet 230, a sealant 240, a first contact hole 250, a first conductive adhesive 252, a second contact hole 260, and a second conductive adhesive 262. The protective sheet 230 is located above the touch sensing electrode layer 228 to protect the front panel laminate 220. Furthermore, the touch sensing electrode layer 228 is located between the protective sheet 230 and the second substrate 226. The sealant 240 surrounds the front panel laminate 220 and is located between the first substrate 210 and the protective sheet 230 to support the protective sheet 230 above the touch sensing electrode layer 228. In addition, the first contact hole 250 is located between the common electrode layer 224 and the thin film transistor layer 212, and the first conductive adhesive 252 is located in the first contact hole 250 to be electrically connected to the common electrode layer 224 and the thin film transistor layer 212. The second contact hole 260 is located between the touch sensing electrode layer 228 and the thin film transistor layer 212, and the second conductive adhesive 262 is located in the second contact hole 260 to be electrically connected to the touch sensing electrode layer 228 and the thin film transistor layer 212.

In this embodiment, when an electric field between the pixel electrode 216 of the first substrate 210 (i.e., the pixel electrode 216 of the thin film transistor layer 212 which is included as part of the first substrate 210) and the common electrode layer 224 is changed, the black charged particles 223 and the white charged particles 225 move upward or downward in accordance with the directions of the electric field, such that each of the microcapsules 221 displays black or white. Therefore, users can see images displayed by the electronic paper display 200. Moreover, the second conductive adhesive 262 located in the second contact hole 260 is electrically connected to the touch sensing electrode layer 228 and the thin film transistor layer 212, such that the electronic paper display 200 has a touch function.

The touch sensing electrode layer 228 may be directly formed on the second surface 232 of the second substrate 226 by methods of slit coating, photolithography, or screen coating. The material of the protective sheet 230 may include silicon oxide (SiO2). The material of the sealant 240 may include ultraviolet (UV) curable adhesive. The material of the first conductive adhesive 252 and the second conductive adhesive 262 may include silver glue. The first substrate 210 may be a glass substrate or a quartz substrate. The material of the pixel electrode 216, the common electrode layer 224, and the touch sensing electrode layer 228 may include indium tin oxide (ITO) or indium zinc oxide (IZO). The material of the second substrate 226 may include polyethylene terephthalate (PET), acrylic, or other plastic materials.

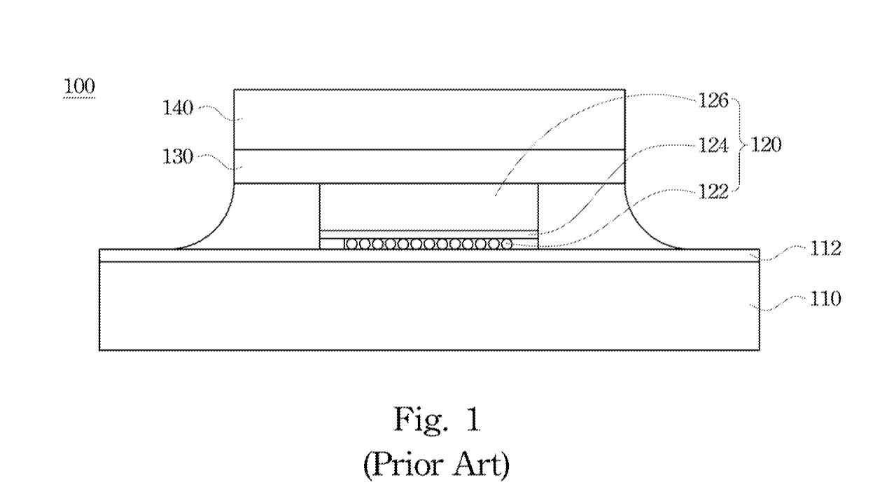

The electronic paper display 200 of the present invention does not employ a configuration in which a touch panel is adhered to a protective sheet, such as in the conventional electronic paper display 100 shown in FIG. 1. As a result, the electronic paper display 200 of the present invention has a reduced thickness and weight. In addition, the touch sensing electrode layer 228 may be formed on the second substrate 226 by methods of slit coating, photolithography, or screen coating, such that the manufacturing productivity of the electronic paper display 200 produced by using the aforementioned methods is better than when adhering a touch panel to a protective sheet. As a result, the optical property and the reflective efficiency of the electronic paper display 200 are enhanced when compared to conventional configurations.

It is to be noted that much of the information described in the above embodiments will not be repeated in the following descriptions, and only aspects related to the electronic ink layer 222 will be described.

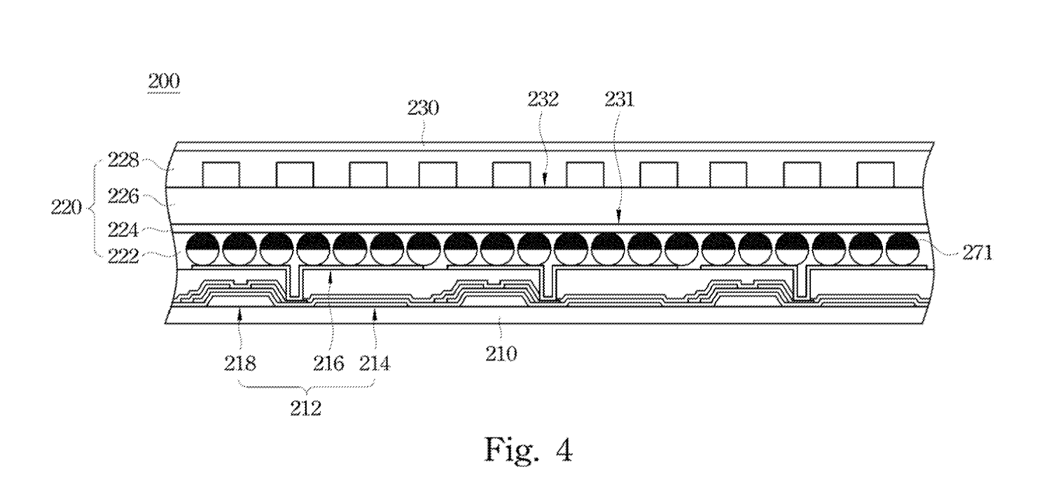

FIG. 4 is a partial sectional view of an electronic paper display 200 of an embodiment of the present invention. As shown in FIG. 4, the front panel laminate 220 includes the second substrate 226, the common electrode layer 224, the electronic ink layer 222, and the touch sensing electrode layer 228. However, the difference between this embodiment and the aforementioned embodiment is that the electronic ink layer 222 includes bicolor charged particles 271 (e.g., black and white) instead of the microcapsules 221 shown in FIG. 3. Images can similarly be displayed by the electronic paper display 200 using the bicolor charged particles 271.

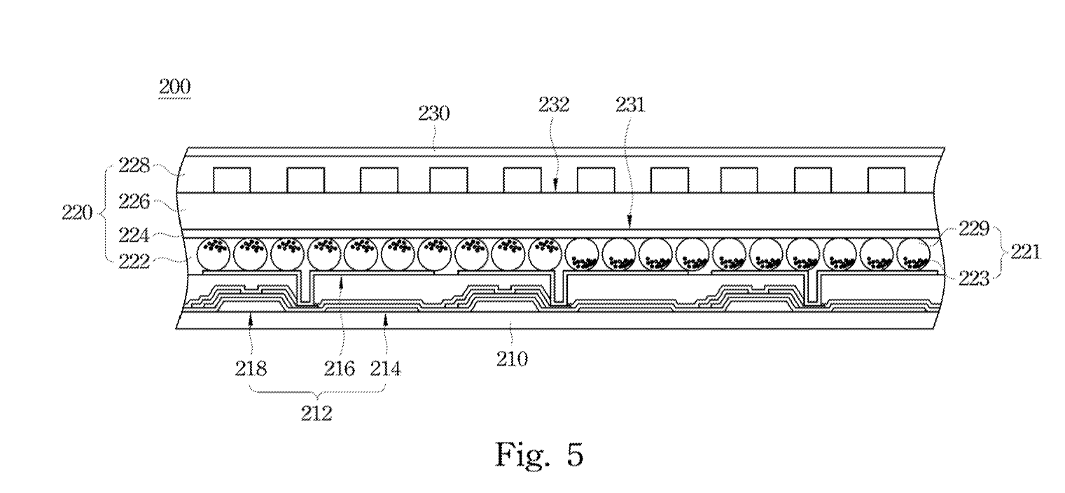

FIG. 5 is a partial sectional view of an electronic paper display 200 of an embodiment of the present invention. As shown in FIG. 5, the front panel laminate 220 includes the second substrate 226, the common electrode layer 224, the electronic ink layer 222, and the touch sensing electrode layer 228. However, the difference between this embodiment and the aforementioned embodiment is that each of the microcapsules 221 of the electronic ink layer 222 includes a non-transparent fluid (e.g., a white fluid) 229 and the black charged particles 223. Because the black charged particles 223 may move upward or downward in accordance with directions of the electric field, images can similarly be displayed by the electronic paper display 200 using the black charged particles 223 and the non-transparent fluid 229.

In the aforementioned embodiments, the electronic paper display 200 may only display two different colors. In the following description, the electronic paper display 200 capable of displaying colored images will be described.

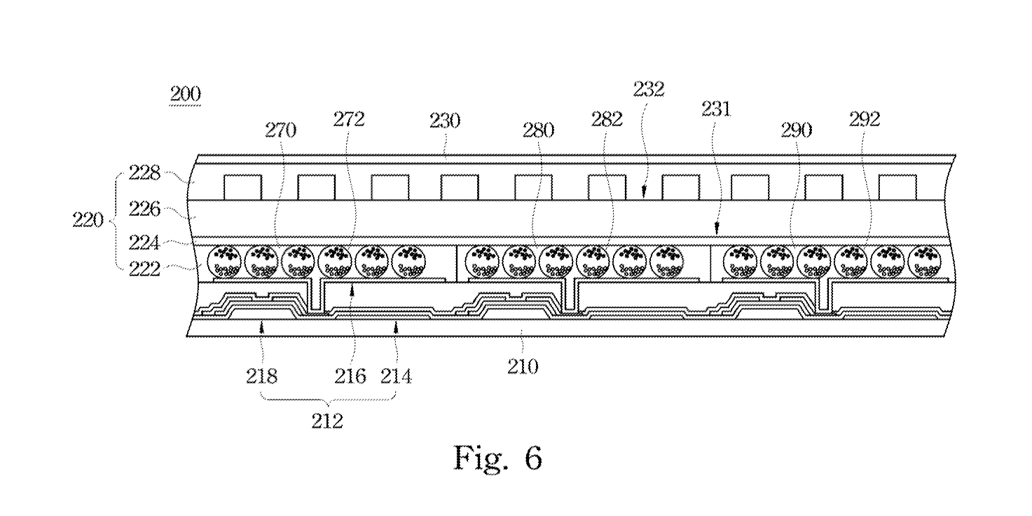

FIG. 6 is a partial sectional view of an electronic paper display 200 of an embodiment of the present invention. As shown in FIG. 6, the front panel laminate 220 includes the second substrate 226, the common electrode layer 224, the electronic ink layer 222, and the touch sensing electrode layer 228. The electronic ink layer 222 includes a first ink material pattern 270, a second ink material pattern 280, and a third ink material pattern 290. First microcapsules 272 are located in the first ink material pattern 270, second microcapsules 282 are located in the second ink material pattern 280, and third microcapsules 292 are located in the third ink material pattern 290. Moreover, the first microcapsules 272, the second microcapsules 282, and the third microcapsules 292 respectively include charged dyes with different colors. For example, each of the first microcapsules 272 includes a red charged dye, each of the second microcapsules 282 includes a green charged dye, and each of the third microcapsules 292 includes a blue charged dye. When the charged dyes are driven by the electric field, the electronic paper display 200 may display colored images.

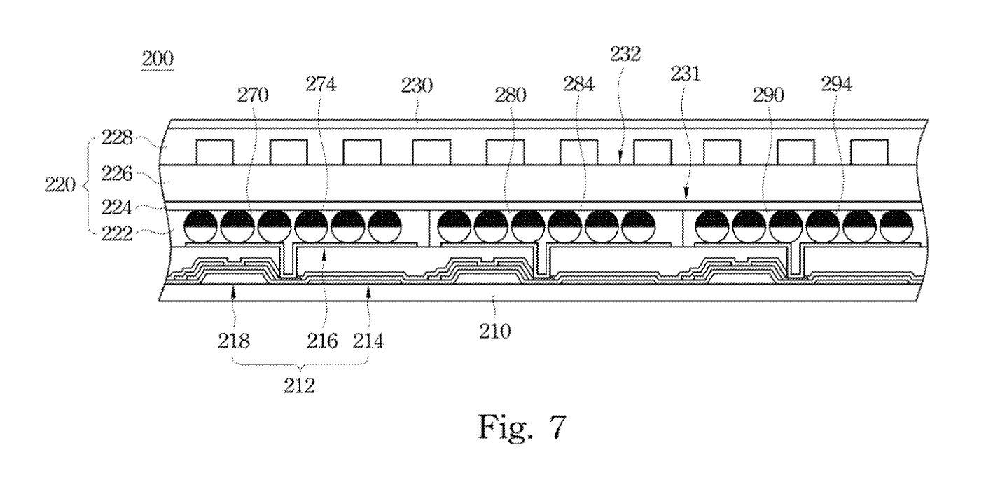

FIG. 7 is a partial sectional view of an electronic paper display 200 of an embodiment of the present invention. As shown in FIG. 7, the front panel laminate 220 includes the second substrate 226, the common electrode layer 224, the electronic ink layer 222, and the touch sensing electrode layer 228. The difference between this embodiment and the aforementioned embodiment is that the electronic ink layer 222 includes first bicolor charged particles 274, second bicolor charged particles 284, and third bicolor charged particles 294 instead of the first microcapsules 272, the second microcapsules 282, and the third microcapsules 292 shown in FIG. 6, respectively. The first bicolor charged particles 274, the second bicolor charged particles 284, and the third bicolor charged particles 294 have different colors.

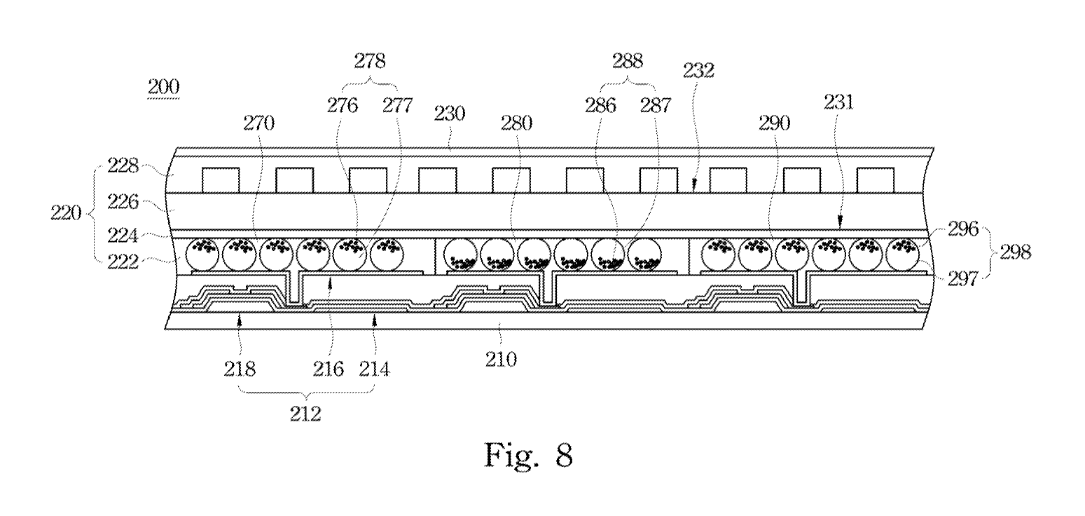

FIG. 8 is a partial sectional view of an electronic paper display 200 of an embodiment of the present invention. As shown in FIG. 8, the front panel laminate 220 includes the second substrate 226, the common electrode layer 224, the electronic ink layer 222, and the touch sensing electrode layer 228. The difference between this embodiment and the aforementioned embodiment shown in FIG. 6 is that each of first microcapsules 278 of the electronic ink layer 222 includes first charged particles 276 and a first non-transparent fluid 277, each of second microcapsules 288 of the electronic ink layer 222 includes second charged particles 286 and a second non-transparent fluid 287, and each of third microcapsules 298 of the electronic ink layer 222 includes third charged particles 296 and a third non-transparent fluid 297. The first charged particles 276, the second charged particles 286, and the third charged particles 296 have different colors.

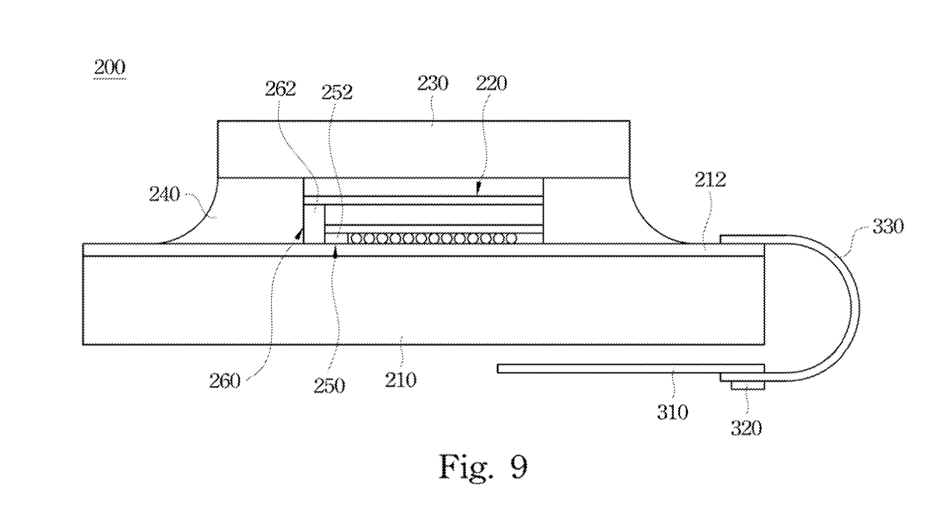

FIG. 9 is a sectional view of an electronic paper display 200 of another embodiment of the present invention. As shown in FIG. 9, the electronic paper display 200 may further include a printed circuit board 310, a chip 320, and a packaging element 330. The chip 320 is mounted on the printed circuit board 310, and the packaging element 330 is electrically connected to the thin film transistor layer 212 and the printed circuit board 310.

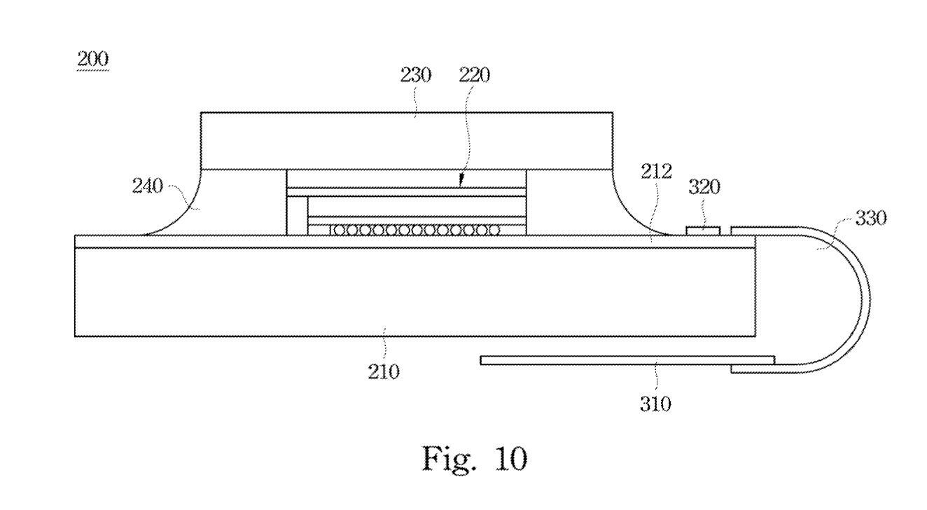

FIG. 10 is a sectional view of an electronic paper display 200 of an embodiment of the present invention. The electronic paper display 200 includes the printed circuit board 310, the chip 320, and the packaging element 330. The chip 320 is mounted on the first substrate 210, and the packaging element 330 is electrically connected to the thin film transistor layer 212 and the printed circuit board 310. The electronic paper display 200 of this embodiment may be produced by a chip on glass (COG) method.

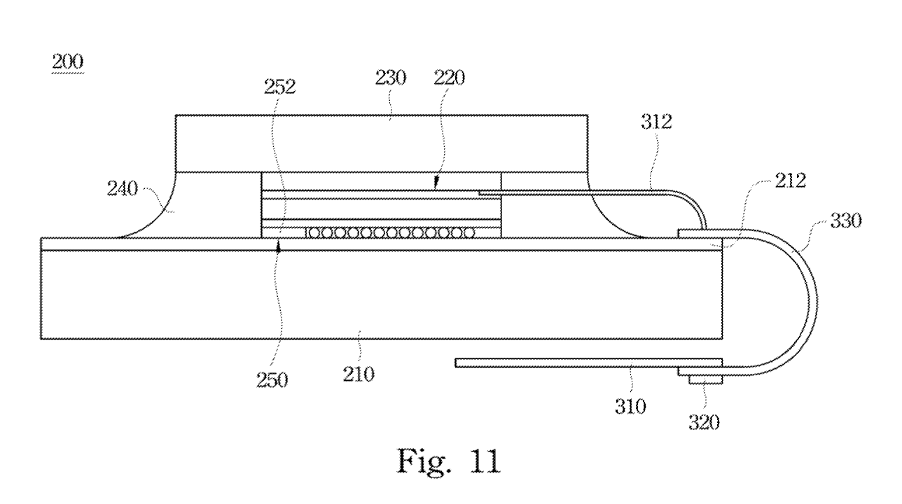

FIG. 11 is a sectional view of an electronic paper display 200 of another embodiment of the present invention. The difference between this embodiment and the aforementioned embodiment shown in FIG. 9 is that the electronic paper display 200 does not have the second contact hole 260 and the second conductive adhesive 262, and a flexible printed circuit board 312 extending from the packaging element 330 is used for electrical connection to the touch sensing electrode layer of the front panel laminate 220.

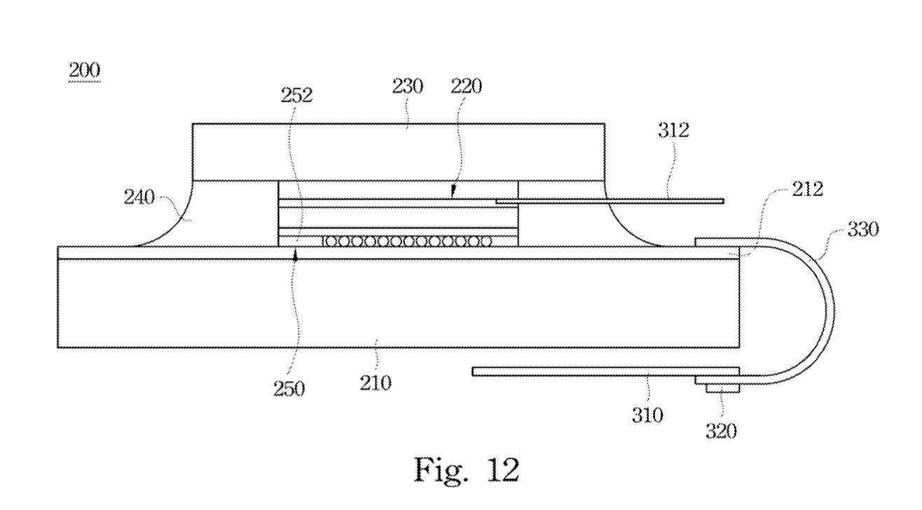

FIG. 12 is a sectional view of an electronic paper display 200 of an embodiment of the present invention. The difference between this embodiment and the aforementioned embodiment shown in FIG. 9 is that the electronic paper display 200 does not have the second contact hole 260 and the second conductive adhesive 262, and the independent flexible printed circuit board 312 is used for electrical connection to the touch sensing electrode layer of the front panel laminate 220.

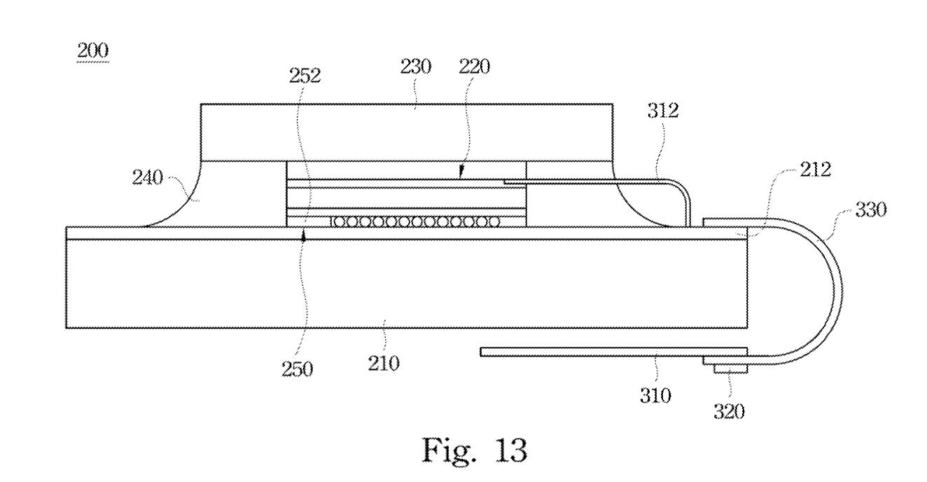

FIG. 13 is a sectional view of an electronic paper display 200 of an embodiment of the present invention. The difference between this embodiment and the aforementioned embodiment shown in FIG. 9 is that the electronic paper display 200 does not have the second contact hole 260 and the second conductive adhesive 262, and the flexible printed circuit board 312 is used for electrical connection to the touch sensing electrode layer of the front panel laminate 220. In this embodiment, an end of the flexible printed circuit board 312 is mounted on the first substrate 210, and signals may be transmitted from the packaging element 330 to external devices.

Compared with the conventional electronic paper display shown in FIG. 1, the front panel laminate includes the touch sensing electrode layer formed on the second substrate, and the second conductive adhesive located in the second contact hole is electrically connected to the touch sensing electrode layer and the thin film transistor layer, such that the electronic paper display has a touch function. In addition, the electronic paper display of the present invention does not employ a configuration in which a touch panel is adhered to a protective sheet, so the electronic paper display has a reduced thickness and weight. Furthermore, the touch sensing electrode layer may be formed on the second substrate by methods of slit coating, photolithography, or screen coating, such that the manufacturing productivity of the electronic paper display produced by using the aforementioned methods is better than when adhering a touch panel to a protective sheet. As a result, the optical property and the reflective efficiency of the electronic paper display of the present invention are enhanced, ultimately improving the product competitiveness of the electronic paper display.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. An electronic paper display comprising:
a first substrate comprising a thin film transistor layer;
a front panel laminate located on the thin film transistor layer, wherein the front panel laminate comprises:
a second substrate comprising a first surface and a second surface, wherein the first surface faces the first substrate, and the second surface faces away from the first surface;
a common electrode layer located on the first surface of the second substrate;
an electronic ink layer located between the thin film transistor layer and the common electrode layer; and
a touch sensing electrode layer directly formed on the second surface of the second substrate.

2. The electronic paper display as claimed in claim 1, further comprising:
a protective sheet located above the touch sensing electrode layer for protecting the front panel laminate.

3. The electronic paper display as claimed in claim 2, wherein the touch sensing electrode layer is located between the protective sheet and the second substrate.

4. The electronic paper display as claimed in claim 2, further comprising:
a sealant surrounding the front panel laminate and located between the first substrate and the protective sheet for supporting the protective sheet above the touch sensing electrode layer.

5. The electronic paper display as claimed in claim 4, wherein the material of the sealant comprises ultraviolet curable adhesive.

6. The electronic paper display as claimed in claim 1, further comprising:
a first contact hole located between the common electrode layer and the thin film transistor layer; and
a first conductive adhesive located in the first contact hole for electrical connection to the common electrode layer and the thin film transistor layer.

7. The electronic paper display as claimed in claim 1, further comprising:
a second contact hole located between the touch sensing electrode layer and the thin film transistor layer; and
a second conductive adhesive located in the second contact hole for electrical connection to the touch sensing electrode layer and the thin film transistor layer.

8. The electronic paper display as claimed in claim 1, wherein the electronic ink layer comprises a plurality of microcapsules, and each of the microcapsules comprises:
a fluid; and
a plurality of charged particles located in the fluid.

9. The electronic paper display as claimed in claim 1, wherein the electronic ink layer comprises a plurality of bicolor charged particles.

10. The electronic paper display as claimed in claim 1, wherein the material of the second substrate comprises polyethylene terephthalate (PET).
